(19) United States
(12) Patent Application Publication
(10) Pub. No.: US 2007/0271321 A1
(43) Pub. Date: Nov. 22, 2007

(54) TRANSFORMS WITH REDUCE COMPLEXITY AND/OR IMPROVE PRECISION BY MEANS OF COMMON FACTORS

(75) Inventors: Yuriy Reznik, San Diego, CA (US); Arianne T. Hinds, Boulder, CO (US)

Correspondence Address: QUALCOMM INCORPORATED, 5775 MOREHOUSE DR., SAN DIEGO, CA, 92121, US

(73) Assignee: QUALCOMM, INC., San Diego, CA (US)

(21) Appl. No.: 11/621,948

(22) Filed: Jan. 10, 2007

Related U.S. Application Data
(60) Provisional application No. 60/758,464, filed on Jan. 11, 2006.

(51) Int. Cl. G06F 17/14

(52) U.S. Cl. 708/402

(57) ABSTRACT

Techniques for efficiently performing transforms on data are described. In one design, an apparatus performs multiplication of a group of data values with a group of rational dyadic constants that approximates at least one irrational constant scaled by a common factor. Each rational dyadic constant is a rational number with a dyadic denominator. The common factor is selected based on pre-computed numbers of operations for multiplication of a data value by different possible values of at least one rational dyadic constant. The pre-computed numbers of operations may be stored in a look-up table or some other data structure and may be used to evaluate different possible values for the common factor. The use of the common factor may reduce complexity and/or improve precision. The multiplication may be performed for various transforms such DCT, IDCT, etc.

### CLAIM OF PRIORITY UNDER 35 U.S.C. § 119

The present application claims priority to provisional U.S. Application Ser. No. 60/758,464, filed Jan. 11, 2006, entitled “Efficient Multiplication-Free Implementations of Scaled Discrete Cosine Transform (DCT) and Inverse Discrete Cosine Transform (IDCT),” assigned to the assignee hereof and incorporated herein by reference.

### BACKGROUND

1. Field

The present disclosure relates generally to processing, and more specifically to techniques for performing transforms on data.

2. Background

Transforms are commonly used to convert data from one domain to another domain. For example, discrete cosine transform (DCT) is commonly used to transform data from spatial domain to frequency domain, and inverse discrete cosine transform (IDCT) is commonly used to transform data from frequency domain to spatial domain. DCT is widely used for image/video compression to spatially decorrelate blocks of picture elements (pixels) in images or video frames. The resulting transform coefficients are typically much less dependent on each other, which makes these coefficients more suitable for quantization and encoding. DCT also exhibits energy compaction property, which is the ability to map most of the energy of a block of pixels to only few (typically low order) transform coefficients. This energy compaction property can simplify the design of encoding algorithms.

Transforms such as DCT and IDCT may be performed on large quantity of data. Hence, it is desirable to perform transforms as efficiently as possible. Furthermore, it is desirable to perform computation for transforms using simple hardware in order to reduce cost and complexity.

There is therefore a need in the art for techniques to efficiently perform transforms on data.

### SUMMARY

Techniques for efficiently performing transforms on data are described herein. According to an aspect, an apparatus performs multiplication of a group of data values with a group of rational dyadic constants that approximates at least one irrational constant scaled by a common factor. Each rational dyadic constant is a rational number with a dyadic denominator. The common factor is selected based on pre-computed numbers of operations for multiplication of a data value by different possible values of at least one rational dyadic constant. The pre-computed numbers of operations may be stored in a look-up table or some other data structure and may be used to evaluate different possible values for the common factor. The use of the common factor may reduce complexity and/or improve precision. The multiplication may be performed for various transforms such DCT, IDCT, etc.

Various aspects and features of the disclosure are described in further detail below.

### BRIEF DESCRIPTION OF THE DRAWINGS

FIG. 1 shows a flow graph of an 8-point IDCT.

FIG. 2 shows a flow graph of an 8-point DCT.

FIG. 3 shows a flow graph of an 8-point IDCT with common factors.

FIG. 4 shows a look-up table storing the numbers of operations for multiplication with different rational dyadic constant values.

FIG. 5 shows a block diagram of a decoding system.

### DETAILED DESCRIPTION

The techniques described herein may be used for various types of transforms such as DCT, IDCT, discrete Fourier transform (DFT), inverse DFT (IDFT), modulated lapped transform (MLT), inverse MLT, modulated complex lapped transform (MCLT), inverse MCLT, etc. The techniques may also be used for various applications such as image, video, and audio processing, communication, computing, data networking, data storage, graphics, etc. In general, the techniques may be used for any application that uses a transform. For clarity, the techniques are described below for DCT and IDCT, which are commonly used in image and video processing.

A one-dimensional (1D) N-point DCT and a 1D N-point IDCT of type II may be defined as follows:

$$\begin{matrix}X [ k ] = \frac{c ( k )}{2} \cdot {\sum }_{n = 0}^{N - 1} x [ n ] \cdot cos \frac{( 2 n + 1 ) \cdot k π}{2 N} , and & Eq ( 1 ) \\ x [ n ] = {\sum }_{k = 0}^{N - 1} \frac{c ( k )}{2} \cdot X [ k ] \cdot cos \frac{( 2 n + 1 ) \cdot k π}{2 N} , \\ where c ( k ) = \{ \begin{matrix}1 / \sqrt{2} & if k = 0 \\ 1 & otherwise ,\end{matrix} & Eq ( 2 )\end{matrix}$$

x[n] is a 1D spatial domain function, and
X[k] is a 1D frequency domain function.

The 1D DCT in equation (1) operates on N spatial domain values x[0] through x[N-1] and generates N transform coefficients X[0] through X[N-1]. The 1D IDCT in equation (2) operates on N transform coefficients and generates N spatial domain values. Type II DCT is one type of transform and is commonly believed to be one of the most efficient transforms among several energy compacting transforms proposed for image/video compression.

The 1D DCT may be used for a two 2D DCT, as described below. Similarly, the 1D IDCT may be used for a 2D IDCT. By decomposing the 2D DCT/IDCT into a cascade of 1D DCTs/IDCTs, the efficiency of the 2D DCT/IDCT is dependent on the efficiency of the 1D DCT/IDCT. In general, 1D DCT and 1D IDCT may be performed on any vector size, and 2D DCT and 2D IDCT may be performed on any block size. However, 8×8 DCT and 8×8 IDCT are commonly used for image and video processing, where N is equal to 8. For example, 8×8 DCT and 8×8 IDCT are used as standard building blocks in various image and video coding standards such as JPEG, MPEG-1, MPEG-2, MPEG-4 (P.2), H.261, H.263, etc.

The 1D DCT and 1D IDCT may be implemented in their original forms shown in equations (1) and (2), respectively. However, substantial reduction in computational complexity may be realized by finding factorizations that result in as few multiplications and additions as possible. A factorization for a transform may be represented by a flow graph that indicates specific operations to be performed for that transform.

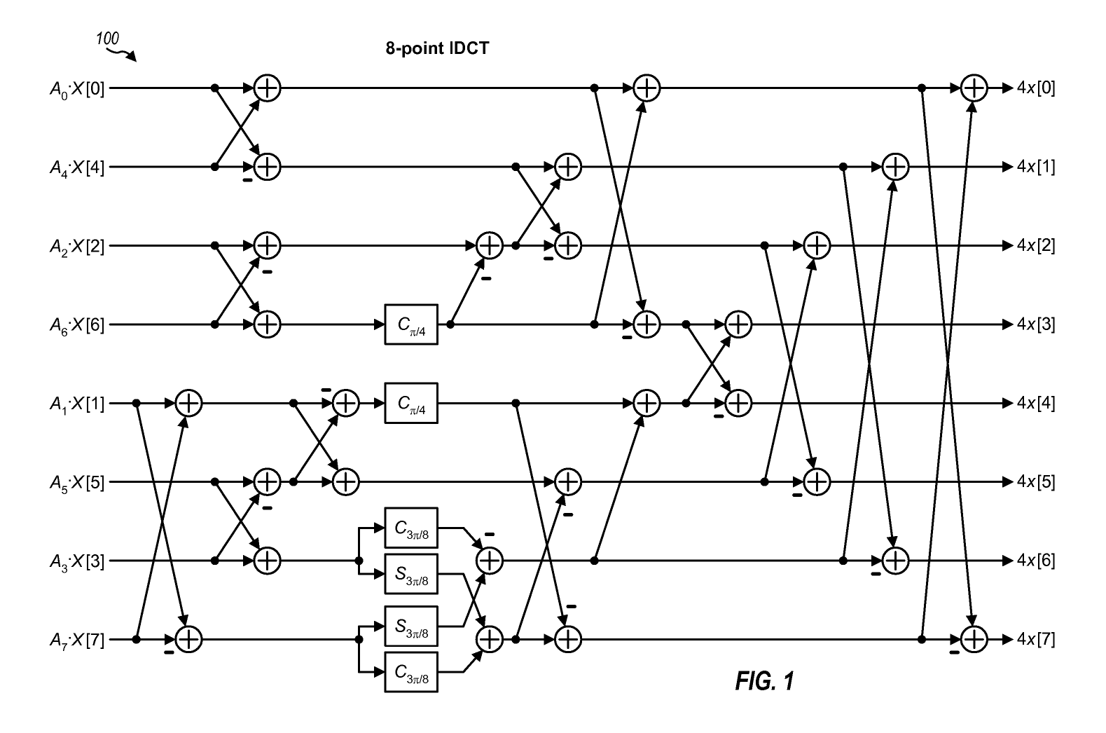

FIG. 1 shows a flow graph 100 of an example factorization of an 8-point IDCT. In flow graph 100, each addition is represented by symbol “⊕” and each multiplication is represented by a box. Each addition sums or subtracts two input values and provides an output value. Each multiplication multiplies an input value with a transform constant shown inside the box and provides an output value. The factorization in FIG. 1 has six multiplications with the following constant factors:
C_{π/4}=cos (π/4)≈0.707106781,
C_{3π/8}=cos(3π/8)≈0.382683432, and
S_{3π/8}=sin(3π/8)≈0.923879533.

Flow graph 100 receives eight scaled transform coefficients A₀·X[0] through A₇·X[7], performs an 8-point IDCT on these coefficients, and generates eight output samples x[0] through x[7]. A₀ through A₇ are scale factors and are given below:

$$\begin{matrix}{A}_{0} = \frac{1}{2 \sqrt{2}} \approx 0.3535533906 , & {A}_{1} = \frac{cos ( 7 π / 16 )}{2 sin ( 3 π / 8 ) - \sqrt{2}} \approx 0.4499881115 , \\ {A}_{2} = \frac{cos ( π / 8 )}{\sqrt{2}} \approx 0.6532814824 , & {A}_{3} = \frac{cos ( 5 π / 16 )}{\sqrt{2} + 2 cos ( 3 π / 8 )} \approx 0.2548977895 , \\ {A}_{4} = \frac{1}{2 \sqrt{2}} \approx 0.3535533906 , & {A}_{5} = \frac{cos ( 3 π / 16 )}{\sqrt{2} - 2 cos ( 3 π / 8 )} \approx 1.2814577239 , \\ {A}_{6} = \frac{cos ( 3 π / 8 )}{\sqrt{2}} \approx 0.2705980501 , & {A}_{7} = \frac{cos ( π / 16 )}{\sqrt{2} + 2 sin ( 3 π / 8 )} \approx 0.3006724435 .\end{matrix}$$

Flow graph 100 includes a number of butterfly operations. A butterfly operation receives two input values and generates two output values, where one output value is the sum of the two input values and the other output value is the difference of the two input values. For example, the butterfly operation on input values A₀·X[0] and A₄·X[4] generates an output value A₀·X[0]+A₄·X[4] for the top branch and an output value A₀·X[0]−A₄·X[4] for the bottom branch.

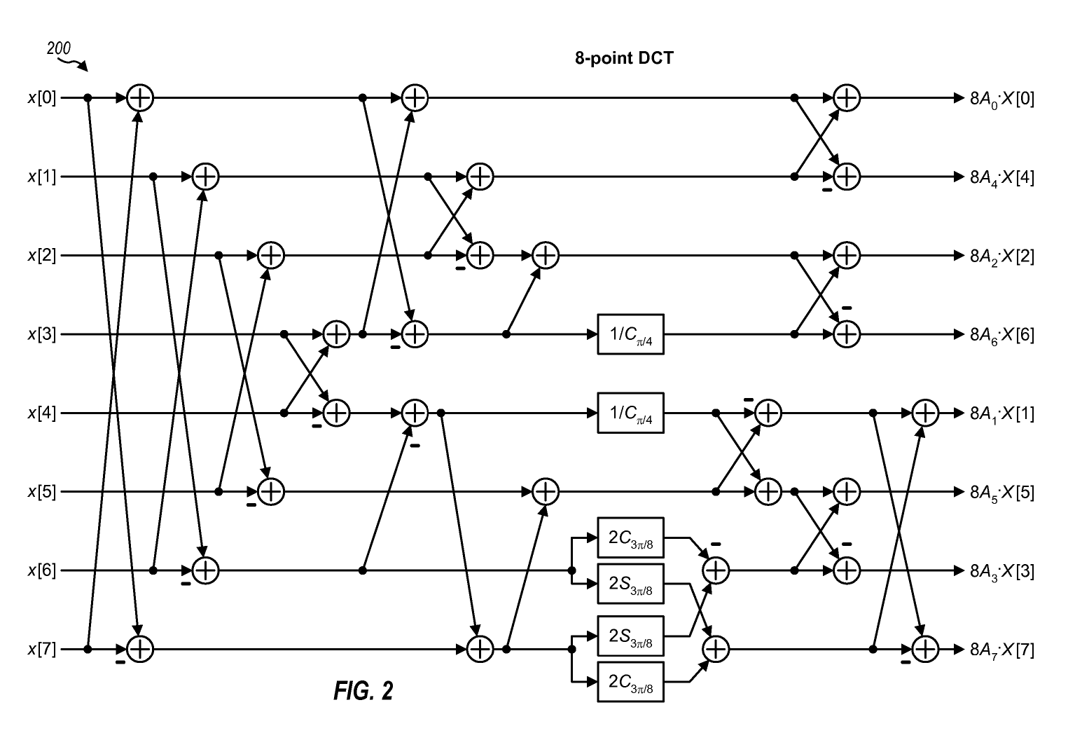

FIG. 2 shows a flow graph 200 of an example factorization of an 8-point DCT. Flow graph 200 receives eight input samples x[0] through x[7], performs an 8-point DCT on these input samples, and generates eight scaled transform coefficients 8A₀·X[0] through 8A₇·X[7]. The scale factors A₀ through A₇ are given above. The factorization in FIG. 2 has six multiplications with constant factors 1/C_{π/4}, 2C_{3π/8} and 2S_{3π/8}.

The flow graphs for the IDCT and DCT in FIGS. 1 and 2 are similar and involve multiplications by essentially the same constant factors (with the difference in 1/2). Such similarity may be advantageous for implementation of the DCT and IDCT on an integrated circuit. In particular, the similarity may enable savings of silicon or die area to implement the butterflies and the multiplications by transform constants, which are used in both the forward and inverse transforms.

The factorization shown in FIG. 1 results in a total of 6 multiplications and 28 additions, which are substantially fewer than the number of multiplications and additions required for direct computation of equation (2). The factorization shown in FIG. 2 also results in a total of 6 multiplications and 28 additions, which are substantially fewer than the number of multiplications and additions required for direct computation of equation (1). The factorization in FIG. 1 performs plane rotation on two intermediate variables with C_{3π/8} and S_{3π/8}. The factorization in FIG. 2 performs plane rotation on two intermediate variables with 2C_{3π/8} and 2S_{3π/8}. A plane rotation is achieved by multiplying an intermediate variable with both sine and cosine, e.g., cos (3π/8) and sin (3π/8) in FIG. 1. The multiplications for plane rotation may be efficiently performed using the computation techniques described below.

FIGS. 1 and 2 show example factorizations of an 8-point IDCT and an 8-point DCT, respectively. These factorizations are for scaled IDCT and scaled DCT, where “scaled” refers to the scaling of the transform coefficients X[0] through X[7] with known scale factors A₀ through A₇, respectively. Other factorizations have also been derived by using mappings to other known fast algorithms such as a Cooley-Tukey DFT algorithm or by applying systematic factorization procedures such as decimation in time or decimation in frequency. In general, factorization reduces the number of multiplications but does not eliminate them.

The multiplications in FIGS. 1 and 2 are with irrational constants representing the sine and cosine of different angles, which are multiples of π/8 for the 8-point DCT and IDCT. An irrational constant is a constant that is not a ratio of two integers. The multiplications with irrational constants may be more efficiently performed in fixed-point integer arithmetic when each irrational constant is approximated by a rational dyadic constant. A rational dyadic constant is a rational constant with a dyadic denominator and has the form c/2^{b}, where b and c are integers and b>0. Multiplication of an integer variable with a rational dyadic constant may be achieved with logical and arithmetic operations, as described below. The number of logical and arithmetic operations is dependent on the manner in which the computation is performed as well as the value of the rational dyadic constant.

In an aspect, common factors are used to reduce the total number of operations for a transform and/or to improve the precision of the transform results. A common factor is a constant that is applied to one or more intermediate variables in a transform. An intermediate variable may also be referred to as a data value, etc. A common factor may be absorbed with one or more transform constants and may also be accounted for by altering one or more scale factors. A common factor may improve the approximation of one or more (irrational) transform constants by one or more rational dyadic constants, which may then result in a fewer total number of operations and/or improved precision.

In general, any number of common factors may be used for a transform, and each common factor may be applied to any number of intermediate variables in the transform. In one design, multiple common factors are used for a transform and are applied to multiple groups of intermediate variables of different sizes. In another design, multiple common factors are applied to multiple groups of intermediate variables of the same size.

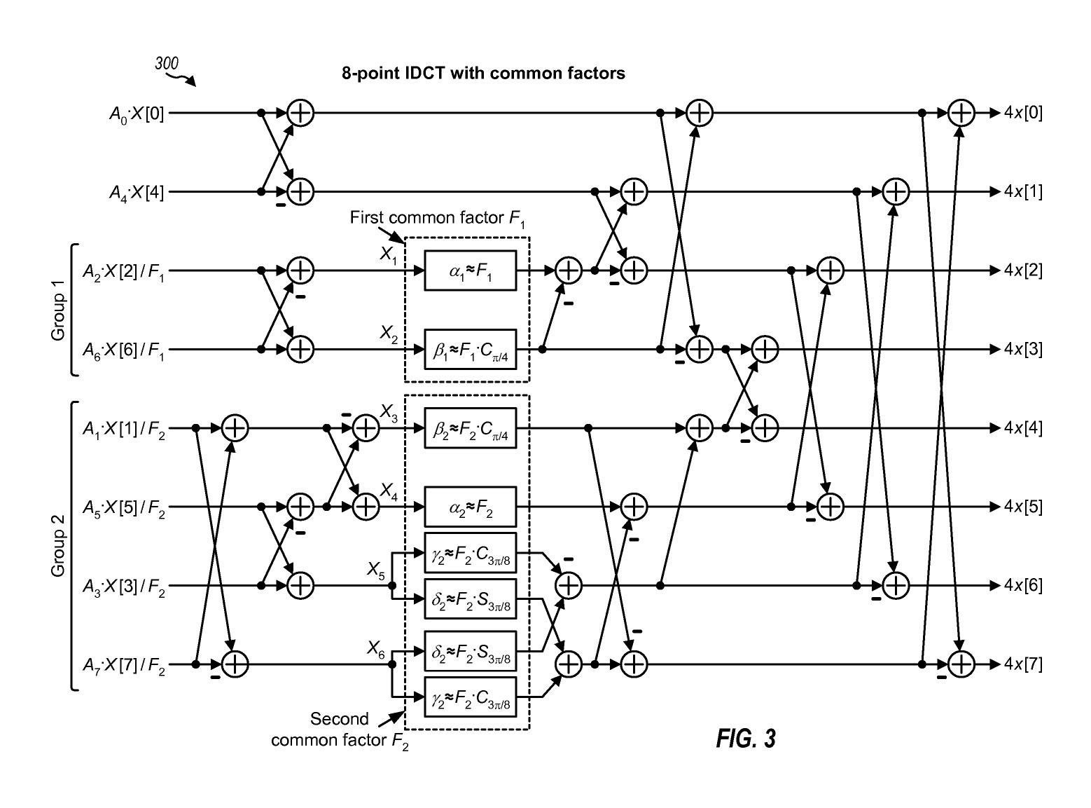

FIG. 3 shows a flow graph 300 of an 8-point IDCT with common factors. Flow graph 300 uses the same factorization as flow graph 100 in FIG. 1. However, flow graph 300 uses two common factors for two groups of intermediate variables.

A first common factor F₁ is applied to a first group of two intermediate variables X₁ and X₂, which is generated based on transform coefficients X[2] and X[6]. The first common factor F₁ is multiplied with X₁, is absorbed with transform constant C_{π/4}, and is accounted for by altering scale factors A₂ and A₆. A second common factor F₂ is applied to a second group of four intermediate variables X₃ through X₆, which is generated based on transform coefficients X[1], X[3], X[5] and X[7]. The second common factor F₂ is multiplied with X₄, is absorbed with transform constants C_{π/4}, C_{3π/8} and S_{3π/8}, and is accounted for by altering scale factors A₁, A₃, A₅ and A₇.

The first common factor F₁ may be approximated with a rational dyadic constant α₁, which may be multiplied with X₁ to obtain an approximation of the product X₁·F₁. A scaled transform factor F₁·C_{π/4} may be approximated with a rational dyadic constant β₁, which may be multiplied with X₂ to obtain an approximation of the product X₂·F₁·C_{π/4}. An altered scale factor A₂/F₁ may be applied to transform coefficient X[2]. An altered scale factor A₆/F₁ may be applied to transform coefficient X[6].

The second common factor F₂ may be approximated with a rational dyadic constant α₂, which may be multiplied with X₄ to obtain an approximation of the product X₄·F₂. A scaled transform factor F₂·C_{π/4} may be approximated with a rational dyadic constant β₂, which may be multiplied with X₃ to obtain an approximation of the product X₃·F₂·C_{π/4}. A scaled transform factor F₂·C_{3π/8} may be approximated with a rational dyadic constant γ₂, and a scaled transform factor F₂·S_{3π/8} may be approximated with a rational dyadic constant β₂. Rational dyadic constant γ₂ may be multiplied with X₅ to obtain an approximation of the product X₅·F₂·C_{3π/8} and also with X₆ to obtain an approximation of the product X₆·F₂·C_{3π/8}. Rational dyadic constant β₂ may be multiplied with X₅ to obtain an approximation of the product X₅·F₂·S_{3π/8} and also with X₆ to obtain an approximation of the product X₆·F₂·S_{3π/8}. Altered scale factors A₁/F₂, A₃/F₂, A₅/F₂ and A₇/F₂ may be applied to transform coefficients X[1], X[3], X[5] and X[7], respectively.

Six rational dyadic constants α₁, β₁, α₂, β₂, γ₂ and δ₂ may be defined for six constants, as follows:
α₁≈F₁, β₁≈F₁·cos(π/4), Eq (3)
α₂≈F₂, β₂≈F₂·cos(π/4), γ₂≈F₂·cos(3π/8).

FIG. 3 shows an example use of common factors for a specific factorization of an 8-point IDCT. Common factors may be used for other factorizations of the IDCT and also for the DCT and other types of transforms. In general, a common factor may be applied to a group of at least one intermediate variable in a transform. This group of intermediate variable(s) may be generated from a group of input values (e.g., as shown in FIG. 3) or used to generate a group of output values (e.g., not shown in FIG. 3). The common factor may be accounted for by the scale factors applied to the input values or the output values.

Multiple common factors may be applied to multiple groups of intermediate variables, and each group may include any number of intermediate variables. The selection of the groups may be dependent on various factors such as the factorization of the transform, where the transform constants are located within the transform, etc. Multiple common factors may be applied to multiple groups of intermediate variables of the same size (not shown in FIG. 3) or different sizes (as shown in FIG. 3). For example, three common factors may be used for the factorization shown in FIG. 3, with a first common factor being applied to intermediate variables X₁ and X₂, a second common factor being applied to intermediate variables X₃, X₄, X₅ and X₆, and a third common factor being applied to two intermediate variables generated from X[0] and X[4].

Multiplication of an intermediate variable x with a rational dyadic constant u may be performed in various manners in fixed-point integer arithmetic. The multiplication may be performed using logical operations (e.g., left shift, right shift, bit-inversion, etc.), arithmetic operations (e.g., add, subtract, sign-inversion, etc.) and/or other operations. The number of logical and arithmetic operations needed for the multiplication of x with u is dependent on the manner in which the computation is performed and the value of the rational dyadic constant u. Different computation techniques may require different numbers of logical and arithmetic operations for the same multiplication of x with u. A given computation technique may require different numbers of logical and arithmetic operations for the multiplication of x with different values of u.

A common factor may be selected for a group of intermediate variables based on criteria such as:
The number of logical and arithmetic operations to perform multiplication, and
The precision of the results.

In general, it is desirable to minimize the number of logical and arithmetic operations for multiplication of an intermediate variable with a rational dyadic constant. On some hardware platforms, arithmetic operations (e.g., additions) may be more complex than logical operations, so reducing the number of arithmetic operations may be more important. In the extreme, computational complexity may be quantified based solely on the number of arithmetic operations, without taking into account logical operations. On some other hardware platforms, logical operations (e.g., shifts) may be more expensive, and reducing the number of logical operations (e.g., reducing the number of shift operations and/or the total number of bits shifted) may be more important. In general, a weighted average number of logical and arithmetic operations may be used, where the weights may represent the relative complexities of the logical and arithmetic operations.

The precision of the results may be quantified based on various metrics such as those given in Table 6 below. In general, it is desirable to reduce the number of logical and arithmetic operations (or computational complexity) for a given precision. It may also be desirable to trade off complexity for precision, e.g., to achieve higher precision at the expense of some additional operations.

As shown in FIG. 3, for each common factor, multiplication may be performed on a group of intermediate variables with a group of rational dyadic constants that approximates a group of at least one irrational constant (for at least one transform factor) scaled by that common factor. Multiplication in fixed-point integer arithmetic may be performed in various manners. For clarity, computation techniques that perform multiplication with shift and add operations and using intermediate results are described below.

Multiplications in a transform, e.g., the IDCT shown in FIG. 3, may be efficiently performed in fixed-point integer arithmetic using computation techniques that approximate multiplication of an integer variable x with one or more irrational constants with a series of intermediate values generated by shift and add operations and using intermediate results to reduce the total number of operations. Each irrational constant may be approximated with a rational dyadic constant, as follows:
μ≈c/2^{b}, Eq (4)
where μ is the irrational constant to be approximated, c/2^{b} is the rational dyadic constant, b and c are integers, and b>0. The series of intermediate values is determined by the one or more rational dyadic constants being multiplied with integer variable x. The computation techniques may be illustrated by the following examples.

In FIG. 1, multiplication of integer variable x with transform constant C_{π/4} in fixed-point integer arithmetic may be achieved by approximating constant C_{π/4} with a rational dyadic constant, as follows:

$${C}_{π / 4}^{8} = \frac{181}{256} = \frac{b 010110101}{b 100000000} , \qquad Eq ( 5 )$$

where C_{π/4}⁸ is a rational dyadic constant that is an 8-bit approximation of C_{π/4}.

Multiplication of integer variable x by constant C_{π/4}⁸ may be expressed as:
y=(x·181)/256 . Eq (6)

The multiplication in equation (6) may be achieved with the following series of operations:

$$\begin{matrix}{y}_{1} = x , & // 1 \\ {y}_{2} = {y}_{1} + ( {y}_{1} >> 2 ) , & // 101 \\ {y}_{3} = {y}_{1} - ( {y}_{2} >> 2 ) , & // 01011 \\ {y}_{4} = {y}_{3} + ( {y}_{2} >> 6 ) , & // 010110101.\end{matrix} \qquad Eq ( 7 )$$

The binary value to the right of “//” is an intermediate constant that is multiplied with variable x.

The desired product is equal to y₄, or y₄=y. The multiplication in equation (6) may be performed with three additions and three shifts to generate three intermediate values y₂, y₃ and y₄.

In FIG. 1, multiplication of integer variable x with transform constants C_{3π/8} and S_{3π/8} in fixed-point integer arithmetic may be achieved by approximating constants C_{3π/8} and S_{3π/8} with rational dyadic constants, as follows:

$$\begin{matrix}{C}_{3 π / 8}^{7} = \frac{49}{128} = \frac{b 00110001}{b 10000000} , and & Eq ( 8 ) \\ {S}_{3 π / 8}^{9} = \frac{473}{512} = \frac{b 0111011001}{b 1000000000} , & Eq ( 9 )\end{matrix}$$

where C_{3π/}₈⁷ is a rational dyadic constant that is a 7-bit approximation of C_{3π/8}, and S_{3π/8}⁹ is a rational dyadic constant that is a 9-bit approximation of S_{3π/8}.

Multiplication of integer variable x by constants C_{3π/8}⁷ and S_{3π/8}⁹ may be expressed as:
y=(x·49)/128 and z=(x·473)/512. Eq (10)

The multiplications in equation (10) may be achieved with the following series of operations:

$$\begin{matrix}{w}_{1} = x , & // 1 \\ {w}_{2} = {w}_{1} - ( {w}_{1} >> 2 ) , & // 011 \\ {w}_{3} = {w}_{1} >> 6 , & // 0000001 \\ {w}_{4} = {w}_{2} + {w}_{3} , & // 0110001 \\ {w}_{5} = {w}_{1} - {w}_{3} , & // 0111111 \\ {w}_{6} = {w}_{4} >> 1 , & // 00110001 \\ {w}_{7} = {w}_{5} - ( {w}_{1} >> 4 ) , & // 0111011 \\ {w}_{8} = {w}_{7} + ( {w}_{1} >> 9 ) , & // 0111011001.\end{matrix} \qquad Eq ( 11 )$$

The desired products are equal to w₆ and w₈, or w₆=y and w₈=z. The two multiplications in equation (10) may be jointly performed with five additions and five shifts to generate seven intermediate values w₂ through w₈. Additions of zeros are omitted in the generation of w₃ and w₆. Shifts by zero are omitted in the generation of w₄ and w₅.

For the 8-point IDCT shown in FIG. 1, using the computation techniques described above for multiplications by constants C_{π/4}⁸, C_{3π/8}⁷ and S_{3π/8}⁹, the total complexity for 8-bit precision may be given as: 28+3·2+5·2=44 additions and 3·2+5·2=16 shifts. In general, any desired precision may be achieved by using sufficient number of bits for the approximation of each transform constant.

For the 8-point DCT shown in FIG. 2, irrational constants 1/C_{π/4}, C_{3π/8} and S_{3π/8} may be approximated with rational dyadic constants. Multiplications with the rational dyadic constants may be achieved using the computation techniques described above.

For the IDCT shown in FIG. 3, different values of common factors F₁ and F₂ may result in different total numbers of logical and arithmetic operations for the IDCT and different levels of precision for the output samples x[0] through x[7]. Different combinations of values for F₁ and F₂ may be evaluated. For each combination of values, the total number of logical and arithmetic operations for the IDCT and the precision of the output samples may be determined.

For a given value of F₁, rational dyadic constants α₁ and β₁ may be obtained for F₁ and F₁·C_{π/4}, respectively. The numbers of logical and arithmetic operations may then be determined for multiplication of X₁ with α₁ and multiplication of X₂ with β₁. For a given value of F₂, rational dyadic constants α₂, β₂, γ₂ and δ₂ may be obtained for F₂, F₂ C_{π4}, F₂·C_{3π/8} and F₂·S_{3π/8}, respectively. The numbers of logical and arithmetic operations may then be determined for multiplication of X₄ with α₂, multiplication of X₃ with β₂, and multiplications of X₅ with both 72 and β₂. The number of operations for multiplications of X₆ with γ₂ and δ₂ is equal to the number of operations for multiplications of X₅ with δ₂ and δ₂.

To facilitate the evaluation and selection of the common factors, the number of logical and arithmetic operations may be pre-computed for multiplication with different possible values of rational dyadic constants. The pre-computed numbers of logical and arithmetic operations may be stored in a data structure such as a look-up table, a list, a linked list, a sorted list (a priority queue), an orthogonal sorted list, multiple tables or lists, a combination of table and/or list, etc.

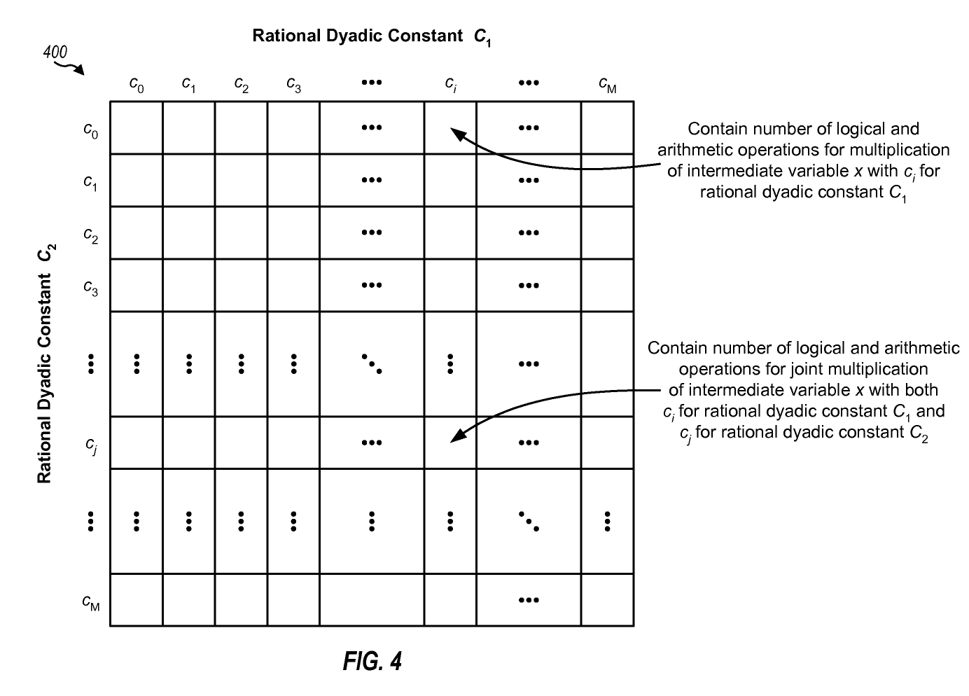

FIG. 4 shows a look-up table 400 that stores the numbers of logical and arithmetic operations for multiplication with different rational dyadic constant values. Look-up table 400 is a two-dimensional table with different possible values of a first rational dyadic constant C₁ on the horizontal axis and different possible values of a second rational dyadic constant C₂ on the vertical axis. The number of possible values for each rational dyadic constant is dependent on the number of bits used for that constant. For example, if C₁ is represented with 13 bits, then there are 8192 possible values for C₁. The possible values for each rational dyadic constant are denoted as c₀, c₁, c₂, . . . , c_{M}, where cₒ=0, c₁ is the smallest non-zero value, and x_{M} is the maximum value (e.g., c_{M}=8191 for 13-bit).

The entry in the i-th column and j-th row of look-up table 400 contains the number of logical and arithmetic operations for joint multiplication of intermediate variable x with both cᵢ for the first rational dyadic constant C₁ and cⱼ for the second rational dyadic constant C₂. The value for each entry in look-up table 400 may be determined by evaluating different possible series of intermediate values for the joint multiplication with cᵢ and cⱼ for that entry and selecting the best series, e.g., the series with the fewest operations. The entries in the first row of look-up table 400 (with c₀=0 for the second rational dyadic constant C₂) contain the numbers of operations for multiplication of intermediate variable x with just cᵢ for the first rational dyadic constant C₁. Since the look-up table is symmetrical, entries in only half of the table (e.g., either above or below the main diagonal) may be filled. Furthermore, the number of entries to fill may be reduced by considering the irrational constants being approximated with the rational dyadic constants C₁ and C₂.

For a given value of F₁, rational dyadic constants α₁ and β₁ may be determined. The numbers of logical and arithmetic operations for multiplication of X₁ with α₁ and multiplication of X₂ with β₁ may be readily determined from the entries in the first row of look-up table 400, where α₁ and β₁ correspond to C₁. Similarly, for a given value of F₂, rational dyadic constants α₂, β₂, γ₂ and δ₂ may be determined. The numbers of logical and arithmetic operations for multiplication of X₄ with α₂ and multiplication of X₃ with β₂ may be determined from the entries in the first row of look-up table 400, where α₂ and β₂ correspond to C₁. The number of logical and arithmetic operations for joint multiplication of X₅ with γ₂ and δ₂ may be determined from an appropriate entry in look-up table 400, where γ₂ may correspond to C₁ and δ₂ may correspond to C₂, or vice versa.

For each possible combination of values for F₁ and F₂, the precision metrics in Table 6 may be determined for a sufficient number of iterations with different random input data. The values of F₁ and F₂ that result in poor precision (e.g., failure of the metrics) may be discarded, and the values of F₁ and F₂ that result in good precision (e.g., pass of the metrics) may be retained.

Tables 1 through 5 show five fixed-point approximations for the IDCT in FIG. 3, which are denoted as algorithms A, B, C, D and E. These approximations are for two groups of factors, with one group including α₁ and β₁ and another group including α₂, β₂, γ₂ and δ₂. For each of Tables 1 through 5, the common factor for each group is given in the first column. The common factors improve the precision of the rational dyadic constant approximations and may be merged with the appropriate scale factors in the flow graph for the IDCT. The original values (which may be 1 or irrational constants) are given in the third column. The rational dyadic constant for each original value scaled by its common factor is given in the fourth column. The series of intermediate values for the multiplication of intermediate variable x with one or two rational dyadic constants is given in the fifth column. The numbers of add and shift operations for each multiplication are given in the sixth and seventh columns, respectively. The total number of add operations for the IDCT is equal to the sum of all add operations in the sixth column plus the last entry again (to account for multiplication of each of X₅ and X₆ with both γ₂ and δ₂) plus 28 add operations for all of the butterflies in the flow graph. The total number of shift operations for the IDCT is equal to the sum of all shift operations in the last column plus the last entry again.

Table 1 gives the details of algorithm A, which uses a common factor of 1/1.0000442471 for each of the two groups.

TABLE 1
Approximation A (42 additions, 16 shifts)

| Group's | | | | | | Num | Num |
|---|---|---|---|---|---|---|---|
| Common | | Original | Dyadic | Multiplication of x with one or two | | of | of |
| Factor | C | Value | Constant | rational dyadic constants | | Adds | Shifts |
| 1/F₁ = | α₁ | 1 | 1 | y = x | | 0 | 0 |
| 1.0000442471 | β₁ | cos(π/4) | $\frac{181}{256}$ | y₂ = x + (x >> 2); y₃ = x − (y₂ >> 2); y = y₃ + (y₂ >> 6); | // 101 // 01011 // 010110101 | 3 | 3 |
| 1/F₂ = | α₂ | 1 | 1 | y = x; | 0 | 0 | |
| 1.0000442471 | β₂ | cos(π/4) | $\frac{181}{256}$ | y₂ = x + (x >> 2); y₃ = x − (y₂ >> 2); y = y₃ + (y₂ >> 6); | // 101 // 01011 // 010110101 | 3 | 3 |
| | γ₂ | cos(3π/8) | $\frac{3135}{8192}$ | w₂ = x − (x >>4); w₃ = w₂ + (x >>10); | // 01111 // 01111000001 | 4 | 5 |
| | δ₂ | sin(3π/8) | $\frac{473}{512}$ | y = (x − (w₃ >> 2)) >>1; z = w₃ − (w₂ >> 6); | // 00110000111111 // 0111011001 | | |

Table 2 gives the details of algorithm B, which uses a common factor of 1/1.0000442471 for the first group and a common factor of 1/1.02053722659 for the second group.

TABLE 2
Approximation B (43 additions, 17 shifts)

| Group's | | | | | | Num | Num |
|---|---|---|---|---|---|---|---|
| Common | | Original | Dyadic | Multiplication of x with one or two | | of | of |
| Factor | C | Value | Constant | rational dyadic constants | | Adds | Shifts |
| 1/F₁ = | α₁ | 1 | 1 | y = x | | 0 | 0 |
| 1.0000442471 | β₁ | cos(π/4) | $\frac{181}{256}$ | y₂ = x + (x >> 2); y₃ = x − (y₂ >> 2); y = y₃ + (y₂ >> 6); | // 101 // 01011 // 010110101 | 3 | 3 |
| 1/F₂ = | α₂ | 1 | $\frac{8027}{8192}$ | y₂ = y + (y >> 5); y₃ = y₂ + y₂ >> 2); y = x − (y₃ >> 6); | // 100001 // 10100101 // 01111101011011 | 3 | 3 |
| 1.02053722659 | β₂ | cos(π/4) | $\frac{1419}{2048}$ | y₂ = x + (x >> 7); y₃ = y₂ >> 1; y₄ = y₂ + y₃; y = y₃ + (y₄ >> 3); | // 10000001 // 010000001 // 010110001011 | 3 | 3 |
| | γ₂ | cos(3π/8) | 3/8 | w₂ = x + (x >>1); | // 11 | 3 | 4 |
| | | | | w₃ = w₂ + (x >> 6); | // 1100001 | | |
| | δ₂ | sin(3π/8) | $\frac{927}{1024}$ | y = x − (w₃ >> 4); z = w₂ >> 2; | // 01110011111 // 0011 | | |

Table 3 gives the details of algorithm C, which uses a common factor of 1/0.87734890555 for the first group and a common factor of 1/1.02053722659 for the second group.

TABLE 3
Approximation C (44 additions, 18 shifts)

| Group's | | | | | | Num | Num |
|---|---|---|---|---|---|---|---|
| Common | | Original | Dyadic | Multiplication of x with one or two | | of | of |
| Factor | C | Value | Constant | rational dyadic constants | | Adds | Shifts |
| 1/F₁ = | α₁ | 1 | $\frac{577}{512}$ | y₂ = x + (x >> 6); y = x + (y₂ >> 3); | // 1000001 // 1001000001 | 2 | 2 |
| 0.87734890555 | β₁ | cos(π/4) | $\frac{51}{64}$ | y₂ = x − (x >> 2); y = y₂ + (y₂ >> 4); | // 011 // 0110011 | 2 | 2 |
| 1/F₂ = | α₂ | 1 | $\frac{8027}{8192}$ | y₂ = x + (x >> 5); y₃ = y₂ + (y₂ >> 2); y = x − (y₃ >> 6); | // 100001 // 10100101 // 01111101011011 | 3 | 3 |
| | β₂ | cos(π/4) | $\frac{1419}{2048}$ | y₂ = x + (x >> 7); y₃ = y₂ >> 1; y₄ = y₂ + y₃; y = y₃ + (y₄ >> 3); | // 10000001 // 010000001 // 110000011 // 010110001011 | 3 | 3 |
| | γ₂ | cos(3π/8) | 3/8 | w₂ = x + (x >> 1); | // 11 | 3 | 4 |
| | | | | w₃ = w₂ + (x >> 6); | // 1100001 | | |
| | δ₂ | sin(3π/8) | $\frac{927}{1024}$ | y = x − (w₃ >> 4); z = w₂ >> 2); | // 01110011111 // 0011 | | |

Table 4 gives the details of algorithm D, which uses a common factor of 1/0.87734890555 for the first group and a common factor of 1/0.89062054308 for the second group.

TABLE 4
Approximation D (45 additions, 17 shifts)

| Group's | | | | | | Num | Num |
|---|---|---|---|---|---|---|---|
| Common | | Original | Dyadic | Multiplication of x with one or two | | of | of |
| Factor | C | Value | Constant | rational dyadic constants | | Adds | Shifts |
| 1/F₁ = | α₁ | 1 | $\frac{577}{512}$ | y₂ = x + (x >> 6); y = x + (y₂ >> 3); | // 1000001 // 1001000001 | 2 | 2 |
| 0.87734890555 | β₁ | cos(π/4) | $\frac{51}{64}$ | y₂ = x − (x >> 2); y = y₂ + (y₂ >> 4); | // 011 // 0110011 | 2 | 2 |
| 1/F₂ = | α₂ | 1 | $\frac{4599}{4096}$ | y₂ = x − (x >> 9); y = y₂ + (y₂ >> 3); | // 0111111111 // 1000111110111 | 2 | 2 |
| 0.89062054308 | β₂ | cos(π/4)/ $\frac{813}{1024}$ | y₂ = x − (x >> 4); y₃ = x + (y₂ >> 4); y = y₃ − (y₃ >> 2); | // 01111 // 100001111 // 01100101101 | 3 | 3 | |
| | γ₂ | cos(3π/8) | 55/128 | w₂ = x + (x >> 3); | // 1001 | 4 | 4 |
| | | | | w₃ = w₂ >> 4; | // 00001001 | | |
| | δ₂ | sin(3π/8) | $\frac{4249}{4096}$ | w₄ = w₂ + w₃; y = x + (w₄ >> 5); z = (x >> 1) − w₃; | // 10011001 // 1000010011001 // 00110111 | | |

Table 5 gives the details of algorithm E, which uses a common factor of 1.087734890555 for the first group and a common factor of 1/1.22387468002 for the second group.

TABLE 5
Approximation E (48 additions, 20 shifts)

| Group's | | | | | | Num | Num |
|---|---|---|---|---|---|---|---|
| Common | | Original | Dyadic | Multiplication of x with one or two | | of | of |
| Factor | C | Value | Constant | rational dyadic constants | | Adds | Shifts |
| 1/F₁ = | α₁ | 1 | $\frac{577}{512}$ | y₂ = x + (x >> 6); y = x + (y₂ >> 3); | // 1000001 // 1001000001 | 2 | 2 |
| 0.87734890555 | β₁ | cos(π/4) | $\frac{51}{64}$ | y₂ = x − (x >> 2); y = y₂ + (y₂ >> 4); | // 011 // 0110011 | 2 | 2 |
| 1/F₂ = | α₂ | 1 | $\frac{13387}{{2}^{14}}$ | y₂ = x − (x >> 4); y₃ = x >> 1; y₄ = y₃ + (y₂ >> 7); y₅ = y₄ + (y₄ >> 2); y = y₃ + (y₅ >> 1); | // 01111 // 01 // 010000001111 // 01010001001011 // 011010001001011 | 4 | 5 |
| | β₂ | cos(π/4) | $\frac{4733}{8192}$ | y₂ = x >> 1; y₃ = x + y₂; y₄ = x + y₃; y₅ = y₂ + (y₄ >> 5); y = y₅ − (y₃ >> 12); | // 01 // 11 // 101 // 0100101 // 01001001111101 | 4 | 3 |
| | γ₂ | cos(3π/8) | 5123/2¹⁴ | w₂ = x >> 2; | // 001 | 4 | 4 |
| | | | | w₃ = x − w₂; | // 011 | | |
| | δ₂ | sin(3π/8) | $\frac{773}{1024}$ | w₄ = w₂ + (x >> 4); y = w₃ + (w₄ >> 6); z = w₄ + (w₃ >> 12); | // 00101 // 01100000101 // 001010000000011 | | |

The precision of the output samples from an approximate IDCT may be quantified based on metrics defined in IEEE Standard 1180-1190 and its pending replacement. This standard specifies testing a reference 64-bit floating-point DCT followed by the approximate IDCT using data from a random number generator. The reference DCT receives random data for a block of input pixels and generates transform coefficients. The approximate IDCT receives the transform coefficients (appropriately rounded) and generates a block of reconstructed pixels. The reconstructed pixels are compared against the input pixels using five metrics, which are given in Table 6. Additionally, the approximate IDCT is required to produce all zeros when supplied with zero transform coefficients and to demonstrate near-DC inversion behavior. All five algorithms A through E given above pass all of the metrics in Table 6.

TABLE 6

| Metric | Description | Requirement |
|---|---|---|
| p | Maximum absolute difference | p ≦ 1 |
| | between reconstructed pixels | |
| d[x, y] | Average differences between | \|d[x, y]\| ≦ 0.015 for all [x, y] |
| | pixels | |
| m | Average of all pixel-wise | \|m\| ≦ 0.0015 |
| | differences | |
| e[x, y] | Average square difference | \|e[x, y]\| ≦ 0.06 for all [x, y] |
| | between pixels | |
| n | Average of all pixel-wise | \|n\| ≦ 0.02 |
| | square differences | |

For clarity, much of the description above is for an 8-point scaled IDCT and an 8-point scaled DCT. The techniques described herein may be used for any type of transform such as DCT, IDCT, DFT, IDFT, MLT, inverse MLT, MCLT, inverse MCLT, etc. The techniques may also be used for any factorization of a transform, with several example factorizations being given in FIGS. 1 through 3. The groups for the common factors may be selected based on the factorization, as described above. The techniques may also be used for transforms of any size, with example 8-point transforms being given in FIGS. 1 through 3. The techniques may also be used in conjunction with any common factor selection criteria such as total number of logical and arithmetic operations, total number of arithmetic operations, precision of the results, etc.

The number of operations for a transform may be dependent on the manner in which multiplications are performed. The computation techniques described above unroll multiplications into series of shift and add operations, use intermediate results to reduce the number of operations, and perform joint multiplication with multiple constants using a common series. The multiplications may also be performed with other computation techniques, which may influence the selection of the common factors.

The transforms with common factors described herein may provide certain advantages such as:
Lower multiplication complexity due to merged multiplications in a scaled phase,
Possible reduction in complexity due to ability to merge scaling with quantization in implementations of JPEG, H.263, MPEG-1, MPEG-2, MPEG-4 (P.2), and other standards, and
Improved precision due to ability to minimize/distribute errors of fixed-point approximations for irrational constants used in multiplications by introducing common factors that can be accounted for by scale factors.

Transforms with common factors may be used for various applications such as image and video processing, communication, computing, data networking, data storage, graphics, etc. Example use of transforms for video processing is described below.

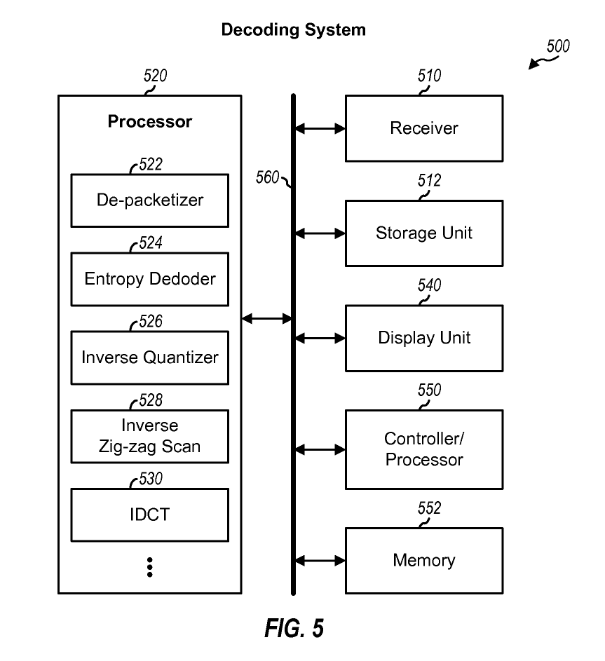

FIG. 5 shows a block diagram of a decoding system 500, which may implement the 8-point IDCT shown in FIG. 3. A receiver 510 may receive compressed data from an encoding system, and a storage unit 512 may store the received compressed data. A processor 520 processes the compressed data and generates output data. Within processor 520, the compressed data may be de-packetized by a de-packetizer 522, decoded by an entropy decoder 524, inverse quantized by an inverse quantizer 526, placed in the proper order by an inverse zig-zag scan unit 528, and transformed by an IDCT unit 530. IDCT unit 530 may perform IDCTs on the reconstructed transform coefficients in accordance with the techniques described above. Each of units 522 through 530 may be implemented a hardware, firmware and/or software. For example, IDCT unit 530 may be implemented with dedicated hardware, a set of instructions for an ALU, etc.

A display unit 540 displays reconstructed images and video from processor 520. A controller/processor 550 controls the operation of various units in decoding system 500. A memory 552 stores data and program codes for decoding system 500. One or more buses 560 interconnect various units in decoding system 500.

Processor 520 may be implemented with one or more application specific integrated circuits (ASICs), digital signal processors (DSPs), and/or some other type of processors. Alternatively, processor 520 may be replaced with one or more random access memories (RAMs), read only memory (ROMs), electrical programmable ROMs (EPROMs), electrically erasable programmable ROMs (EEPROMs), magnetic disks, optical disks, and/or other types of volatile and nonvolatile memories known in the art.

The techniques described herein may be implemented in hardware, firmware, software, or a combination thereof. For example, the logical (e.g., shift) and arithmetic (e.g., add) operations for multiplication of a data value with a constant value may be implemented with one or more logics, which may also be referred to as units, modules, etc. A logic may be hardware logic comprising logic gates, transistors, and/or other circuits known in the art. A logic may also be firmware and/or software logic comprising machine-readable codes.

In one design, an apparatus comprises a first logic to receive a group of data values and a second logic to perform multiplication of the group of data values with a group of rational dyadic constants that approximates at least one irrational constant scaled by a common factor. Each rational dyadic constant is a rational number with a dyadic denominator. The common factor is selected based on pre-computed numbers of operations for multiplication of a data value by different possible values of at least one rational dyadic constant. The first and second logics may be separate logics, the same common logic, or shared logic.

For a firmware and/or software implementation, multiplication of a data value with a constant value may be achieved with machine-readable codes that perform the desired logical and arithmetic operations. The codes may be hardwired or stored in a memory (e.g., memory 552 in FIG. 5) and executed by a processor (e.g., processor 550) or some other hardware unit.

The techniques described herein may be implemented in various types of apparatus. For example, the techniques may be implemented in different types of processors, different types of integrated circuits, different types of electronics devices, different types of electronics circuits, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a DSP, an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the present disclosure. Various modifications to the disclosure may be readily apparent to those skilled in the art, and the generic principles defined herein may be applied to other designs without departing from the spirit or scope of the disclosure. Thus, the present disclosure is not intended to be limited to the examples shown herein but is to be accorded the widest scope consistent with the principles and novel features disclosed herein.

What is claimed is:

1. An apparatus comprising:
a first logic to receive a group of data values; and
a second logic to perform multiplication of the group of data values with a group of rational dyadic constants that approximates at least one irrational constant scaled by a common factor, each rational dyadic constant being a rational number with a dyadic denominator, the common factor being selected based on pre-computed numbers of operations for multiplication of a data value by different possible values of at least one rational dyadic constant.

2. The apparatus of claim 1, wherein the pre-computed numbers of operations are for arithmetic operations.

3. The apparatus of claim 1, wherein the pre-computed numbers of operations are for logical and arithmetic operations.

4. The apparatus of claim 1, wherein the pre-computed numbers of operations are for shift and add operations.

5. The apparatus of claim 1, wherein the pre-computed numbers of operations are stored in a data structure.

6. The apparatus of claim 1, wherein the pre-computed numbers of operations are stored in a look-up table.

7. The apparatus of claim 6, wherein each entry of the look-up table indicates the number of logical and arithmetic operations for multiplication of a data value with a specific value for each of the at least one rational dyadic constant.

8. The apparatus of claim 6, wherein the look-up table comprises a plurality of columns and a plurality of rows, each column corresponding to a different value of a first rational dyadic constant, and each row corresponding to a different value of a second rational dyadic constant, and wherein an entry for a particular column and a particular row indicates the number of operations for multiplication of a data value by a first rational dyadic constant value associated with the particular column and a second rational dyadic constant value associated with the particular row.

9. The apparatus of claim 8, wherein the number of operations for multiplication of a data value with one rational dyadic constant is determined based on one row of the look-up table, and wherein the number of operations for multiplication of a data value with two rational dyadic constants is determined based on the plurality of columns and the plurality of rows of the look-up table.

10. The apparatus of claim 8, wherein the look-up table comprises 8192 columns for a 13-bit first rational dyadic constant and 8192 rows for a 13-bit second rational dyadic constant.

11. The apparatus of claim 1, wherein the number of rational dyadic constants is greater than the number of irrational constants being approximated by the rational dyadic constants.

12. The apparatus of claim 1, wherein the second logic performs multiplication of a first data value in the group with a first rational dyadic constant that approximates the common factor, and performs multiplication of a second data value in the group with a second rational dyadic constant that approximates an irrational constant scaled by the common factor.

13. The apparatus of claim 1, wherein the at least one irrational constant comprises first and second irrational constants, wherein the group of rational dyadic constants comprises a first rational dyadic constant that approximates the first irrational constant scaled by the common factor and a second rational dyadic constant that approximates the second irrational constant scaled by the common factor.

14. The apparatus of claim 1, wherein the second logic performs multiplication of a data value in the group with a first rational dyadic constant in the group, and performs multiplication of the data value with a second rational dyadic constant in the group.

15. The apparatus of claim 1, wherein the common factor is selected further based on at least one precision metric for results generated from the multiplication of the group of data values with the group of rational dyadic constants.

16. The apparatus of claim 1, wherein the second logic performs the multiplication for a discrete cosine transform (DCT).

17. The apparatus of claim 1, wherein the second logic performs the multiplication for an inverse discrete cosine transform (IDCT).

18. The apparatus of claim 1, wherein the second logic performs the multiplication for an 8-point discrete cosine transform (DCT) or an 8-point inverse discrete cosine transform (IDCT).

19. A method comprising:
receiving a group of data values; and
performing multiplication of the group of data values with a group of rational dyadic constants that approximates at least one irrational constant scaled by a common factor, each rational dyadic constant being a rational number with a dyadic denominator, the common factor being selected based on pre-computed numbers of operations for multiplication of a data value by different possible values of at least one rational dyadic constant.

20. The method of claim 19, wherein the pre-computed numbers of operations are stored in a look-up table.

21. The method of claim 20, wherein the look-up table comprises a plurality of columns and a plurality of rows, each column corresponding to a different value of a first rational dyadic constant, and each row corresponding to a different value of a second rational dyadic constant, and wherein an entry for a particular column and a particular row indicates the number of operations for multiplication of a data value by a first rational dyadic constant value associated with the particular column and a second rational dyadic constant value associated with the particular row.

22. The method of claim 19, wherein the performing multiplication of the group of data values comprises
performing multiplication of a first data value in the group with a first rational dyadic constant that approximates the common factor, and
performing multiplication of a second data value in the group with a second rational dyadic constant that approximates an irrational constant scaled by the common factor.

23. The method of claim 19, wherein the performing multiplication of the group of data values comprises
performing multiplication of a data value in the group with a first rational dyadic constant in the group, and
performing multiplication of the data value with a second rational dyadic constant in the group.

24. An apparatus comprising:
means for receiving a group of data values; and
means for performing multiplication of the group of data values with a group of rational dyadic constants that approximates at least one irrational constant scaled by a common factor, each rational dyadic constant being a rational number with a dyadic denominator, the common factor being selected based on pre-computed numbers of operations for multiplication of a data value by different possible values of at least one rational dyadic constant.

25. The apparatus of claim 24, wherein the pre-computed numbers of operations are stored in a look-up table.

26. The apparatus of claim 25, wherein the look-up table comprises a plurality of columns and a plurality of rows, each column corresponding to a different value of a first rational dyadic constant, and each row corresponding to a different value of a second rational dyadic constant, and wherein an entry for a particular column and a particular row indicates the number of operations for multiplication of a data value by a first rational dyadic constant value associated with the particular column and a second rational dyadic constant value associated with the particular row.

27. The apparatus of claim 24, wherein the means for performing multiplication of the group of data values comprises
means for performing multiplication of a first data value in the group with a first rational dyadic constant that approximates the common factor, and
means for performing multiplication of a second data value in the group with a second rational dyadic constant that approximates an irrational constant scaled by the common factor.

28. The apparatus of claim 24, wherein the means for performing multiplication of the group of data values comprises
means for performing multiplication of a data value in the group with a first rational dyadic constant in the group, and
means for performing multiplication of the data value with a second rational dyadic constant in the group.
